(19) United States
(12) Patent Application Publication
(10) Pub. No.: US 2022/0019982 A1
(43) Pub. Date: Jan. 20, 2022

(54) METHOD AND SYSTEM FOR REAL TIME ASSIGNMENT OF SERVICEMEN IN AN EVENT OF FAULT DETECTION

(71) Applicant: Facilio Inc., Lewes, DE (US)

(72) Inventors: Prabhu RAMACHANDRAN, Chennai (IN); Yogendrababu VENKATAPATHY, Chennai (IN); Rajavel SUBRAMANIAN, Chennai (IN); Shivaraj SELVANATHAN, Chennai (IN)

(73) Assignee: Facilio Inc., Lewes, DE (US)

(21) Appl. No.: 16/932,638

(22) Filed: Jul. 17, 2020

(51) Int. Cl. G06Q 10/00; G06Q 10/06; G06N 20/00; G06N 5/04

(52) U.S. Cl. CPC G06Q 10/20; G06N 5/04; G06N 20/00; G06Q 10/063112

(57) ABSTRACT

The present disclosure provides a system for real time assignment of servicemen in an event of fault detection. A fault detection system receives a first set of data and a past experience data. In addition, the fault detection system analyses the first set of data and the past experience data. Further, the fault detection system determines one or more faults in a plurality of equipment installed in a facility. Furthermore, the ticket generation system generates a one or more tickets based on the one or more faults detected in the plurality of equipment installed in the facility. Moreover, the ticket generation system assigns a plurality of servicemen for handling the one or more faults. Also, the ticket generation system sends alert to the plurality servicemen along with a plurality of information about the one or more faults detected.

### TECHNICAL FIELD

The present disclosure relates to the field of building management systems and, in particular, relates to a method and system for real time assignment of servicemen in an event of fault detection in a facility.

### INTRODUCTION

With the advent in technological advancements over the past few decades, there has been an exponential rise in the number of large facilities. These facilities are big residential complexes, commercial offices, shopping centers and the like. Nowadays, it is a very common to see facilities with multiple equipment. These equipment are located inside a home, an office or any other facility associated with a user. In addition, these equipment are frequently utilized by the user for carrying out various tasks. Examples of these equipment include air handling unit, de-humidifiers, escalators, heating unit, ventilation unit, air conditioning unit, transformer, electricity meter, air conditioning system, fire detection system, elevator system, lightening system, and the like. Further, a majority of the equipment require regular monitoring, maintenance and servicing for ensuring efficient and long term working of the equipment. Currently, there are various facility management systems available in the market which allows the users to control and monitor the working of the equipment inside the facility in real time. These facility management systems allow the users to control lighting, heating, ventilation, air conditioning and the like. Further, there are some systems available in the prior art which allow the users to manage the working of their equipment in real time. In addition, some of the systems allow the users to manage working of specific equipment through a dedicated hardware and mobile application.

### SUMMARY

In a first example, a computer-implemented method is provided. The computer-implemented method enables real time assignment of servicemen in an event of fault detection in a facility. The computer-implemented method includes a first step to receive a first set of data. The first set of data is received from a facility management system. In addition, the facility management system is associated with a plurality of sensors. Further, the plurality of sensors is installed at a plurality of equipment in the facility. Furthermore, the first set of data is time series data. Moreover, the first set of data is received in real time. In addition, the computer-implemented method includes a second step to fetch a past experience data from one or more databases. The past experience data is associated with past experiences of a plurality of servicemen. Further, the past experience data is fetched in real time. Furthermore, the computer-implemented method includes a third step to analyse the first set of data and the past experience data. Moreover, analysis is done using one or more machine learning algorithms. Also, the first set of data and the past experience data are analysed in real time. Also, the computer-implemented method includes a fourth step to detect the one or more faults in at least one equipment of the plurality of equipment based on analysis of the first set of data. In addition, the one or more faults are detected in real time. Further, the computer-implemented method includes a fifth step to generate one or more tickets in the event of detection of the one or more faults in the at least one equipment of the plurality of equipment associated with the facility. Furthermore, the one or more tickets include a plurality of parameters associated with the one or more faults. Moreover, the one or more tickets are generated in real time. Also, the computer-implemented method includes a sixth step to assign the plurality of servicemen for handling the one or more faults detected in the at least one equipment of the plurality of equipment associated with the facility. Also, assignment of the plurality of servicemen is based on a plurality of factors. Also, assignment of the plurality of servicemen is done in real time. Also, the computer-implemented method includes a seventh step of enabling alert for the plurality of servicemen assigned. In addition, alert is sent to the plurality of servicemen assigned for handling the one or more faults. Further, alert is sent to the plurality of servicemen in real time. Furthermore, the computer-implemented method includes an eighth step of sending a plurality of information about the one or more faults associated with the plurality of equipment installed in the facility. The plurality of information is sent to the plurality of servicemen assigned to handle the one or more faults.

In an embodiment of the present disclosure, the plurality of equipment include distribution board, transformer, electricity meter, air conditioning system, fire detection system, circuit breaker, elevator system, electricity meter, circuit disconnects, junction boxes and electric switchgears.

In an embodiment of the present disclosure, the first set of data includes facility temperature, usage time of equipment, equipment behaviour, equipment temperature, equipment output, equipment efficiency and equipment fault history.

In an embodiment of the present disclosure, the past experience data includes total experience, field of expertise, past handled faults, customer's review, mean time to repair, current location, current availability and the like.

In an embodiment of the present disclosure, the plurality of parameters include facility location, faulty equipment placement, type of fault, mean time to repair, required skills and required equipment.

In an embodiment of the present disclosure, the one or more faults include short circuit fault, equipment failure, symmetrical fault, unsymmetrical fault, temperature fault, efficiency fault, equipment noise fault, circuit overload and lightening fault.

In an embodiment of the present disclosure, the plurality of sensors include dynamic pressure sensor, smoke sensor, infrared sensor, humidity sensor, temperature sensor, occupancy sensor, duct sensor, heating ventilation and air conditioning sensor, vibration sensor and ultrasonic sensor.

In an embodiment of the present disclosure, the plurality of factors include availability of servicemen, crafts and skills of servicemen, rating of servicemen, choice of a user, choice of administrator and past experience of servicemen.

In an embodiment of the present disclosure, the computer-implemented method includes comparing equipment behaviour and pre-defined equipment behaviour of each of the plurality of equipment installed in the facility. In addition, comparison is done in real time.

In an embodiment of the present disclosure, the computer-implemented method includes determining facility location, fault location, type of fault, mean time to repair, required equipment and required skills, wherein identification is done in real time.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for real time assignment of servicemen in an event of fault detection in a facility. The method includes a first step to receive a first set of data. The first set of data is received from a facility management system. In addition, the facility management system is associated with a plurality of sensors. Further, the plurality of sensors is installed at a plurality of equipment in the facility. Furthermore, the first set of data is time series data. Moreover, the first set of data is received in real time. In addition, the method includes a second step to fetch a past experience data from one or more databases. The past experience data is associated with past experiences of a plurality of servicemen. Further, the past experience data is fetched in real time. Furthermore, the method includes a third step to analyse the first set of data and the past experience data. Moreover, analysis is done using one or more machine learning algorithms. Also, the first set of data and the past experience data are analysed in real time. Also, the method includes a fourth step to detect the one or more faults in the at least one equipment of the plurality of equipment based on analysis of the first set of data. In addition, the one or more faults are detected in real time. Further, the method includes a fifth step to generate one or more tickets in the event of detection of the one or more faults in the at least one equipment of the plurality of equipment associated with the facility. Furthermore, the one or more tickets includes a plurality of parameters associated with the one or more faults. Moreover, the one or more tickets is generated in real time. Also, the method includes a sixth step to assign the plurality of servicemen for handling the one or more faults detected in the at least one equipment of the plurality of equipment associated with the facility. Also, assignment of the plurality of servicemen is based on a plurality of factors. Also, assignment of the plurality of servicemen is done in real time. Also, the method includes a seventh step of enabling alert for the plurality of servicemen assigned. In addition, alert is sent to the plurality of servicemen assigned for handling the one or more faults. Further, alert is sent to the plurality of servicemen in real time. Furthermore, the method includes an eighth step of sending a plurality of information about the one or more faults associated with the plurality of equipment installed in the facility. The plurality of information is sent to the plurality of servicemen assigned to handle the one or more faults.

In a third example, a non-transitory computer-readable storage medium is provided. The non-transitory computer-readable storage medium encodes computer executable instructions. The computer executable instructions are executed by at least one processor to perform a method for real time assignment of servicemen in an event of fault detection in a facility. The method includes a first step to receive a first set of data. The first set of data is received from a facility management system. In addition, the facility management system is associated with a plurality of sensors. Further, the plurality of sensors is installed at a plurality of equipment in the facility. Furthermore, the first set of data is time series data. Moreover, the first set of data is received in real time. In addition, the method includes a second step to fetch a past experience data from one or more databases. The past experience data is associated with past experiences of a plurality of servicemen. Further, the past experience data is fetched in real time. Furthermore, the method includes a third step to analyse the first set of data and the past experience data. Moreover, analysis is done using one or more machine learning algorithms. Also, the first set of data and the past experience data are analysed in real time. Also, the method includes a fourth step to detect the one or more faults in the at least one equipment of the plurality of equipment based on analysis of the first set of data. In addition, the one or more faults are detected in real time. Further, the method includes a fifth step to generate one or more tickets in the event of detection of the one or more faults in the at least one equipment of the plurality of equipment associated with the facility. Furthermore, the one or more tickets includes a plurality of parameters associated with the one or more faults. Moreover, the one or more tickets is generated in real time. Also, the method includes a sixth step to assign the plurality of servicemen for handling the one or more faults detected in the at least one equipment of the plurality of equipment associated with the facility. Also, assignment of the plurality of servicemen is based on a plurality of factors. Also, assignment of the plurality of servicemen is done in real time. Also, the method includes a seventh step of enabling alert for the plurality of servicemen assigned. In addition, alert is sent to the plurality of servicemen assigned for handling the one or more faults. Further, alert is sent to the plurality of servicemen in real time. Furthermore, the method includes an eighth step of sending a plurality of information about the one or more faults associated with the plurality of equipment installed in the facility. The plurality of information is sent to the plurality of servicemen assigned to handle the one or more faults.

### BRIEF DESCRIPTION OF THE FIGURES

Having thus described the invention in general terms, references will now be made to the accompanying figures, wherein:

FIG. 1 illustrates an interactive computing environment for real time assignment of servicemen in an event of fault detection, in accordance with various embodiments of the present disclosure;

FIGS. 2A and 2B illustrate a flowchart of the method for real time assignment of servicemen in the event of fault detection, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present invention in conjunction with accompanying figures. The embodiments described herein are not intended to limit the scope of the invention, and the present invention should not be construed as limited to the embodiments described. This invention may be embodied in different forms without departing from the scope and spirit of the invention. It should be understood that the accompanying figures are intended and provided to illustrate embodiments of the invention described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

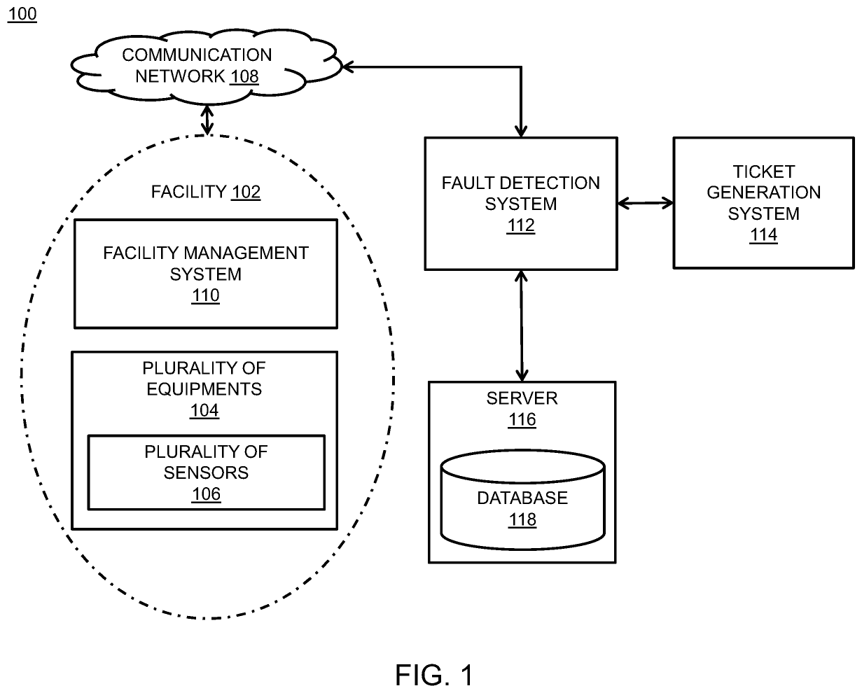

FIG. 1 illustrates an interactive computing environment 100 for real time assignment of servicemen in an event of fault detection in a facility 102, in accordance with various embodiments of the present disclosure. The interactive computing environment 100 shows a relationship between various entities involved in real time assignment of servicemen in the event of fault detection. The interactive computing environment 100 includes the facility 102, a facility management system 110, a plurality of equipment 104 and a plurality of sensors 106. In addition, the interactive computing environment 100 includes a communication network 108, a fault detection system 112, a ticket generation system 114, a server 116 and a database 118. Each of the components of the interactive computing environment 100 interacts with each other to enable real time assignment of servicemen in the event of fault detection.

The interactive computing environment 100 includes the facility 102 as shown in FIG. 1. The facility 102 corresponds to any place, venue, indoor location and the like. Examples of the facility 102 include but may not be limited to a residential facility, office, factory, and the like. In addition, the facility 102 includes the facility management system 110. In general facility management system is computer operated control system installed in facilities to control and monitor electrical and mechanical equipment installed in facility. In addition, facility management system devices includes heating, ventilation, air conditioning subsystems, security subsystems, lighting subsystems, fire alerting subsystems, elevator subsystems and the like, that are capable of managing building functions. In an embodiment of the present disclosure, the facility management system 110 facilitates administrator to monitor and control various functionality of the plurality of equipment 104 installed in the facility 102 in real time. In addition, the facility management system 110 facilitates administrator with a communication device. In an embodiment of the present disclosure, the communication device includes but may not be limited to Bluetooth device, infrared device, modem, network card, smartphone, Wi-Fi device. In an embodiment of the present disclosure, the facility management system 110 collects data from the plurality of sensors 106 placed in the plurality of equipment 104.

In an embodiment of the present disclosure, the facility management system 110 is accessed through a web browser. In an example, the web-browser includes but may not be limited to Opera, Mozilla Firefox, Google Chrome, Internet Explorer, Microsoft Edge, Safari and UC Browser. Further, the web browser runs on any version of the respective web browser of the above-mentioned web browsers.

In addition, the facility management system 110 performs computing operations based on suitable operating system installed inside the facility management system 110. In general, operating system is system software that manages computer hardware and software resources and provides common services for computer programs. In addition, operating system acts as an interface for software installed inside the facility management system 110 to interact with hardware components of the facility management system 110. In an embodiment of the present disclosure, operating system installed inside the facility management system 110 is mobile operating system. In an embodiment of the present disclosure, the facility management system 110 performs computing operations based on any suitable operating system designed for the facility management system 110. In an example, mobile operating system includes but may not be limited to Windows operating system from Microsoft, Android operating system from Google, iOS operating system from Apple, Symbian operating system from Nokia, Bada operating system from Samsung Electronics and BlackBerry operating system. However, operating system is not limited to above mentioned operating systems. In an embodiment of the present disclosure, the facility management system 110 operates on any version of a particular operating system of above-mentioned operating systems.

In another embodiment of the present disclosure, the facility management system 110 performs computing operations based on any suitable operating system designed for controlling and managing the plurality of equipment 104 and the plurality of sensors 106. In an example, operating system installed inside the facility management system 110 is Windows from Microsoft. In another example, operating system installed inside the facility management system 110 is Mac from Apple. In yet another example, operating system installed inside the facility management system 110 is Linux based operating system. In yet another example, operating system installed inside the facility management system 110 may be one of UNIX, Kali Linux, and the like. However, operating system is not limited to above mentioned operating systems.

In an embodiment of the present disclosure, the facility management system 110 operates on any version of Windows operating system. In another embodiment of the present disclosure, the facility management system 110 operates on any version of Mac operating system. In another embodiment of the present disclosure, the facility management system 110 operates on any version of the Linux operating system. In yet another embodiment of the present disclosure, the facility management system 110 operates on any version of a particular operating system of the above-mentioned operating systems

In addition, the facility 102 in the interactive computing environment 100 includes the plurality of equipment 104 as shown in FIG. 1. The plurality of equipment 104 is installed in the facility 102. In addition, the plurality of equipment 104 is associated with plurality of mechanical equipment, plurality of electrical equipment and plurality of electronic equipment. In an embodiment of the present disclosure, the plurality of equipment 104 includes but may not be limited to air handling unit, de-humidifiers, escalators, heating unit, ventilation unit, air conditioning unit, boiler unit, distribution board, transformer, electricity meter, air conditioning system, fire detection system, circuit breaker, elevator system, electricity meter, circuit disconnects, junction boxes, electric switchgears, lightening system, electronic lock system, and intercom system.

Further, the interactive computing environment 100 includes the plurality of sensors 106 as shown in FIG. 1. In general, sensors are devices that recognize any event or change in its surroundings and send information to other electronic devices. In addition, sensor converts physical parameter into signal that can be measured electrically. In an embodiment of the present disclosure, the plurality of sensors 106 is smart sensors installed at various locations in the facility 102. In another embodiment of the present disclosure, the plurality of sensors 106 is placed in the plurality of equipment 104 installed in the facility 102. In yet another embodiment of the present disclosure, the plurality of sensors 106 is IOT based connected sensors. In yet another embodiment of the present disclosure, the plurality of sensors 106 provides ambient parameters. In an example, the plurality of sensors 106 is placed in various rooms, washrooms, corridor, cafeteria, sport complex, auditorium and the like. The plurality of sensors 106 includes dynamic pressure sensor, smoke sensor, infrared sensor, humidity sensor, temperature sensor, occupancy sensor, duct sensor, proximity sensor, light sensor, air quality sensor, touch sensor, biometric sensor, motion sensor heating ventilation and air conditioning sensor, vibration sensor and ultrasonic sensor and the like.

In addition, the plurality of equipment 104 and the plurality of sensors 106 generate a first set of data. The first set data includes data from the plurality of sensors 106 installed in the facility 102. In addition, the first set of data is time series data. In general, output data of sensors is analysed to determine various information related to condition of the plurality equipment and environment of the facility. In an embodiment of the present disclosure, the first set of data includes but may not be limited to facility temperature, usage time of equipment, equipment behaviour, equipment temperature, equipment output, equipment efficiency and equipment fault history, lighting settings, air pressure data, humidity, and air quality index. In addition, collection of the first-set of data uses various methods. In an embodiment of the present disclosure, the method involves wireless digital collection of data for each of the plurality of equipment 104. In addition, the first set of data is then transferred to one or more collecting devices. In an embodiment of the present disclosure, the facility management system 110 installed in the facility 102, collects the first set of data from the plurality sensors 106 and the plurality of equipment 104.

Furthermore, the interactive computing environment 100 includes the communication network 108 as shown in FIG. 1. In an embodiment of the present disclosure, the communication network 108 enables communication device to gain access to internet. In addition, internet connection is established based on a type of network. In an embodiment of the present disclosure, the type of network is a wireless mobile network. In another embodiment of the present disclosure, the type of network is a wired network with a finite bandwidth. In yet another embodiment of the present disclosure, the type of network is a combination of the wireless and the wired network for an optimum throughput of data transmission. Further, the communication network 108 includes set of channels. In addition, each channel of set of channels supports finite bandwidth. Further, finite bandwidth of each channel of the set of channels is based on capacity of network.

The communication network 108 provides medium for sharing information between the communication device and the facility management system 110. Further, the communication network 108 provides a medium of sharing information between the communication device and the fault detection system 112. The communication device is associated with the facility management system 110. In addition, the communication device is associated with the facility management system 110 through the communication network 108.

Further, the medium for communication may be infrared, microwave, radio frequency (RF) and the like. The communication network 108 include but may not be limited to a local area network, a metropolitan area network, a wide area network, a virtual private network, a global area network, a home area network or any other communication network presently known in the art. The communication network 108 is a structure of various nodes or communication devices connected to each other through network topology method. Examples of the network topology include a bus topology, a star topology, a mesh topology and the like.

Moreover, the interactive computing environment 100 includes the fault detection system 112 as shown in FIG. 1. The fault detection system 112 performs various operations on the first set of data received from the facility management system 110 installed in the facility 102. In an embodiment of the present disclosure, the fault detection system 112 fetches a past experience data from one or more databases. The past experience data is associated with the plurality of servicemen. In addition, the past experience data is fetched in real time. In an embodiment of the present disclosure, the past experience data includes but may not be limited to total experience, field of expertise, past handled faults, customer's review, mean time to repair, current location, current availability and the like.

In an embodiment of the present disclosure, the fault detection system 112 receives the first set of data from the facility management system 110 installed in the facility 102. The first set of data is associated with the plurality of sensors 106. In addition, the first set of data is received in real time. In an embodiment of the present disclosure, the plurality of sensors 106 is installed at different locations in the facility 102. In another embodiment of the present disclosure, the plurality of sensors 106 is placed in the plurality of equipment 104 installed in the facility 102. In yet another embodiment of the present disclosure, the plurality of sensors 106 is placed outside of the plurality of equipment 104 installed in the facility 102.

In addition, the fault detection system 112 analyses the past experience data associated with the plurality of servicemen. The analysis of the past experience data is done in real time. In addition, the analysis is employed by using one or more machine learning algorithms. In an embodiment of the present disclosure, the one or more machine learning algorithms include but may not be limited to linear regression, logistic regression, decision tree, sum of vector machine, naïve Bayes, k nearest neighbour, random forest, time series, k-means and the like. Further, the fault detection system 112 performs one or more tasks during analysis. In an embodiment of the present disclosure, the one or more tasks includes but may not be limited to comparing customer ratings of each of the plurality of servicemen, total experience, classification of type of experience of the plurality of servicemen, comparing mean time taken to repair of each of the plurality of servicemen.

In an embodiment of the present disclosure, the fault detection system 112 determines whether the plurality of equipment 104 and the plurality of sensors 106 are operating in a standard state or in a faulty state. In another embodiment of the present disclosure, the fault detection system 112 receives the first-set of data and utilizes the first-set of data to determine whether the plurality of equipment 104 and the plurality of sensors 106 are operating in the standard state or in the faulty state. In addition, the first-set of data are received in real time. The plurality of equipment 104 and the plurality of sensors 106 operate in the faulty state only when there is a problem with the plurality of equipment 104 and the plurality of sensors 106.

Further, the fault detection system 112 analyses the first set of data associated with the plurality of sensors 106. In addition, the fault detection system 112 compares present equipment behaviour with the pre-defined equipment behaviour of each of the plurality of equipment 104 installed in the facility 102. Further, the comparison of present equipment behaviour with pre-defined equipment behaviour of each of the plurality of equipment 104 installed in the facility 102 is done in real time.

Furthermore, the fault detection system 112 detects the one or more faults present in at least one equipment of the plurality of equipment 104 and the plurality of sensors 106 installed in the facility 102. The detection of the one or more faults is based on the analysis of the first set of data associated with the plurality of equipment 104 and the plurality of sensors 106. In addition, the detection of the one or more faults is done in real time. In an embodiment of the present disclosure, the one or more faults includes but may not be limited to short circuit fault, equipment failure, symmetrical fault, unsymmetrical fault, temperature fault, efficiency fault, equipment noise fault, circuit overload and. lightening fault.

Also, the interactive computing environment 100 includes the ticket generation system 114 as shown in FIG. 1. The ticket generation system 114 determines information associated to the one or more faults detected by the fault detection system 112. In an example the ticket generation system 114 determines facility location, faulty equipment placement, type of fault, mean time to repair and the like. In addition, the ticket generation system 114 generates one or more tickets based on the one or more faults detected by the fault detection system 112 after analyses of the first set of data. In addition, the one or more tickets include a plurality of parameters associated with the one or more faults detected by the fault detection system 112. Further the plurality of parameters includes but may not be limited to facility location, faulty equipment placement, type of fault, mean time to repair, required skills and required equipment to repair. Furthermore, the one or more tickets generation is done in real time.

Further, the ticket generation system 114 assigns the plurality of servicemen for handling the one or more faults associated with the plurality of equipment 104 installed in the facility 102. In addition, assignment of the plurality of servicemen is based on a plurality of factors. In an embodiment of the present disclosure, the plurality of factors includes but may not be limited to availability of servicemen, crafts and skills of servicemen, rating of servicemen, choice of a user, choice of administrator and past experience of servicemen. Further, the ticket generation system 114 identifies the plurality of servicemen to be assigned for handling the one or more faults using artificial intelligence. The artificial intelligence considers the plurality of factors during assignment of the plurality of servicemen for handling the one or more faults. Further, assignment of the plurality of servicemen to handle the one or more faults is done in real time. In an embodiment of the present disclosure, assignment of the plurality of servicemen may be done on the basis availability of servicemen. In another embodiment of the present disclosure, assignment of the plurality of servicemen may be done on basis of current location of the plurality of servicemen. In addition, current location of the plurality of servicemen is tracked using application installed in mobile of each of the plurality of servicemen. In yet another embodiment of the present disclosure, assignment of the plurality of servicemen may be done on the basis of craft and skills of each of the plurality of servicemen. In yet another embodiment of the present disclosure, assignment of the plurality of servicemen may be done using round robin method. In general, round robin method is job scheduling algorithm that uses time slices which are assigned to each process in queue or line. In addition, each process is allowed to use central processing unit for given amount of time. In yet another embodiment of the present disclosure, assignment of the plurality of servicemen may be done on the basis of priority of the one or more faults. In yet another embodiment of the present disclosure, assignment of the plurality of servicemen may be done one the basis of rating of each of the plurality of servicemen. In addition, rating of each of the plurality of servicemen is available on mobile application. In yet another embodiment of the present disclosure, assignment of the plurality of servicemen may be done on the basis of choice of user or administrator of the facility 102. In yet another embodiment of the present disclosure, assignment of the plurality of servicemen may be done by considering more than one factors.

In an example, the ticket generation system 114 assigns a serviceman with required skills, who is nearest to location of fault and has high rating on application to handle faults. In another example, the ticket generation system 114 assigns a serviceman with required skills, who has more experience to handle faults. In yet another example, user or administrator choses a serviceman to handle faults.

The ticket generation system 114 sends alert on one or more media devices of the plurality of servicemen assigned for handling the one or more faults associated with the plurality of equipment 104 installed in the facility 102. Moreover the ticket generation system 114 sends a plurality of information about the one or more faults associated with the plurality of equipment 104 installed in the building, to the plurality of servicemen assigned for handling the one or more faults detected. In an embodiment of the present disclosure, plurality of information includes but may not be limited to facility location, faulty equipment placement, type of fault, mean time to repair, required skills and required equipment.

In addition, the interactive computing environment 100 includes the database 118 as shown in FIG. 1. The database 118 is where all the information is stored for accessing. The database 118 includes data which is pre-stored in the database and data collected in real-time. The database 118 may be a cloud database or any other database based on the requirement for real time assignment of the plurality of servicemen in event of fault detection. The data is stored in the database 118 in various tables. The tables are matrix that store different type of data in the form rows and columns. In an example, one table may store data related to the plurality of equipment 104 and in other table the past experience data associated with the plurality of servicemen is stored. The database 118 is included inside the server 116.

Further, the interactive computing environment includes the server 116. The server 116 is used to perform task of accepting request and respond to the request of other functions. The server 116 may be a cloud server which is used for cloud computing to enhance the real time processing of the system and using virtual space for task performance. In an embodiment of the present disclosure, the server 116 may be any other server based on the requirement for real time assignment of the plurality servicemen in event of fault detection.

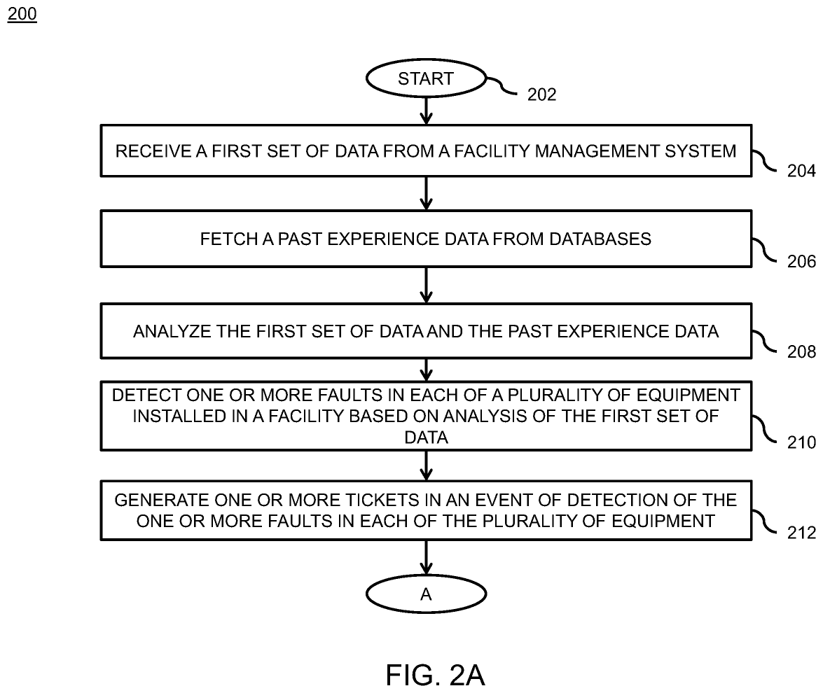

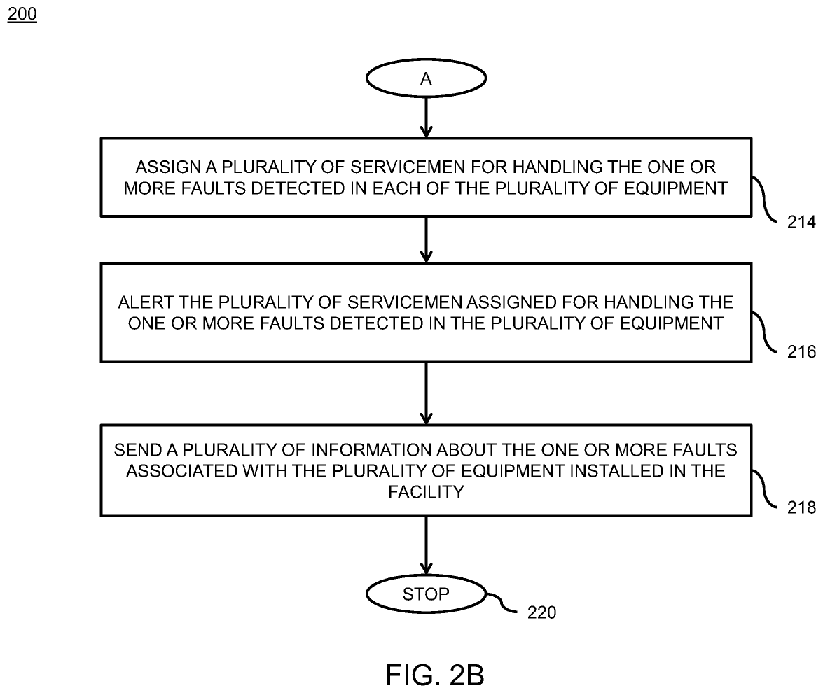

FIGS. 2A and 2B illustrate a flowchart 200 of the method for real time assignment of servicemen in the event of fault detection, in accordance with various embodiments of the present disclosure. It may be noted that in order to explain the method steps of the flowchart 200, references will be made to the elements explained in FIG. 1. The flowchart 200 starts at step 202. At step 204, the fault detection system 112 receives the first set of data from the facility management system 110. At step 206, the fault detection system 112 fetches the past experience data from databases. At step 208, the fault detection system 112 analyzes the first set of data and the past experience data. At step 210, the fault detection system 112 detects the one or more faults in at least one equipment of the plurality of equipment 104 installed in the facility 102 based on analysis of the first set of data. At step 212, the ticket generation system 114 generates the one or more tickets in the event of detection of the one or more faults in each of the plurality of equipment 104. At step 214, the ticket generation system 114 assigns the plurality of servicemen to handle the one or more faults detected in each of the plurality of equipment 104. At step 216, the ticket generation system 114 alerts the plurality of servicemen assigned to handle the one or more faults detected in the plurality of equipment 104. At step 218, the ticket generation system 114 sends the plurality of information about the one or more faults associated with the plurality of equipment 104 installed in the facility 102. The flow chart 200 terminates at step 220.

It may be noted that the flowchart 200 is explained to have above stated process steps; however, those skilled in the art would appreciate that the flowchart 200 may have more/less number of process steps which may enable all the above stated embodiments of the present disclosure.

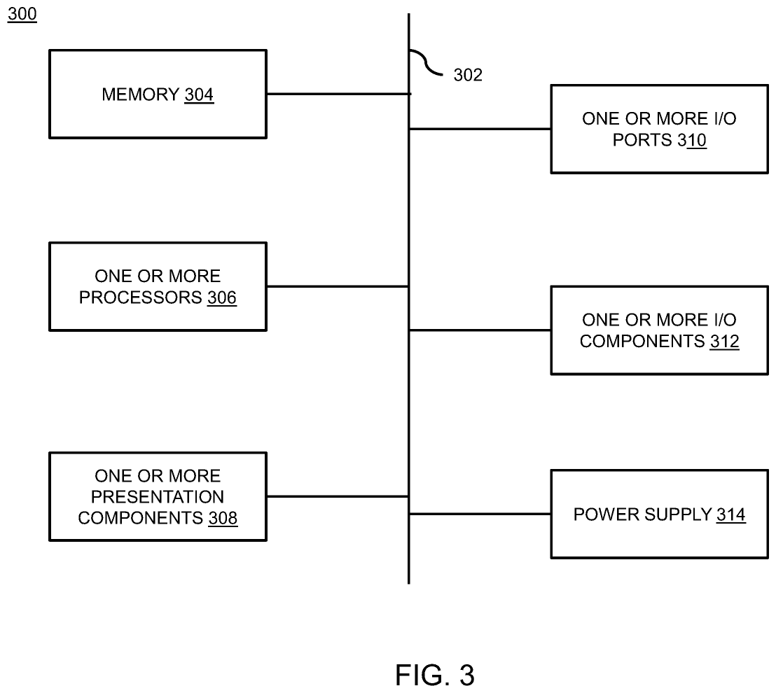

FIG. 3 illustrates a block diagram of a computing device 300, in accordance with various embodiments of the present disclosure. The computing device 300 includes a bus 302 that directly or indirectly couples the following devices: a memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. The distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes the one or more processors that read data from various entities such as the memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to explain the principles of the present technology best and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for real time assignment of servicemen in an event of fault detection in a facility, the computer-implemented method comprising:
receiving, at a fault detection system with a processor, a first set of data from a facility management system, wherein the facility management system is associated with a plurality of sensors, wherein the plurality of sensors is installed at a plurality of equipment in the facility, wherein the first set of data is time series data, wherein the first set of data is received in real time;
fetching, at the fault detection system with the processor, a past experience data from one or more databases, wherein the past experience data is associated with past experiences of a plurality of servicemen, wherein the past experience data is fetched in real time;
analyzing, at the fault detection system with the processor, the first set of data and the past experience data, wherein the analysis is done using one or more machine learning algorithms, wherein the first set of data and the past experience data are analysed in real time;
detecting, at the fault detection system with the processor, one or more faults in at least one equipment of the plurality of equipment installed in the facility based on the analysis of the first set of data, wherein the one or more faults are detected in real time;
generating, at a ticket generation system with a processor, one or more tickets in an event of detection of the one or more faults in the at least one equipment of the plurality of equipment installed in the facility, wherein the one or more tickets comprising a plurality of parameters associated with the one or more faults, wherein the one or more tickets are generated in real time;
assigning, at the ticket generation system with the processor, the plurality of servicemen for handling the one or more faults detected in the at least one equipment of the plurality of equipment installed in the facility, wherein the assignment of the plurality of servicemen is based on a plurality of factors, wherein assignment of the plurality of servicemen is done in real time;
alerting, at the ticket generation system with the processor, the plurality of servicemen assigned for handling the one or more faults detected in the plurality of equipment installed in the facility, wherein the alert is sent to the plurality of servicemen in real time; and
sending, at the ticket generation system with the processor, a plurality of information about the one or more faults associated with the at least one equipment of the plurality of equipment installed in the facility to the plurality of servicemen assigned to handle the one or more faults.

2. The computer-implemented method as recited in claim 1, wherein the plurality of equipment comprising air handling unit, de-humidifiers, escalators, heating unit, ventilation unit, air conditioning unit, boiler unit, distribution board, transformer, electricity meter, air conditioning system, fire detection system, circuit breaker, elevator system, electricity meter, circuit disconnects, junction boxes, electric switchgears, lightening system, electronic lock system, and intercom system.

3. The computer-implemented method as recited in claim 1, wherein the first set of data comprising facility temperature, usage time of equipment, equipment behaviour, equipment temperature, equipment output, equipment efficiency and equipment fault history.

4. The computer-implemented method as recited in claim 1, wherein the past experience data comprising total experience, field of expertise, past handled faults, customer's review, mean time to repair, current location, and current availability.

5. The computer-implemented method as recited in claim 1, wherein the plurality of parameters comprising facility location, faulty equipment placement, type of fault, mean time to repair, required skills, and required equipment.

6. The computer-implemented method as recited in claim 1, wherein the one or more faults comprising short circuit fault, equipment failure, symmetrical fault, unsymmetrical fault, temperature fault, efficiency fault, equipment noise fault, circuit overload and lightening fault.

7. The computer-implemented method as recited in claim 1, wherein the plurality of sensors comprising dynamic pressure sensor, smoke sensor, infrared sensor, humidity sensor, temperature sensor, occupancy sensor, duct sensor, proximity sensor, light sensor, air quality sensor, touch sensor, biometric sensor, motion sensor heating ventilation and air conditioning sensor, vibration sensor and ultrasonic sensor.

8. The computer-implemented method as recited in claim 1, wherein the plurality of factors comprising availability of servicemen, crafts and skills of servicemen, rating of servicemen, choice of a user, choice of administrator and past experience of servicemen.

9. The computer-implemented method as recited in claim 1, further comprising comparing, at the fault detection system with the processor, equipment behaviour and pre-defined equipment behaviour of each of the plurality of equipment installed in the facility, wherein the comparison is done in real time.

10. The computer-implemented method as recited in claim 1, further comprising determining, at the ticket generation system with the processor, facility location, fault location, type of fault, mean time to repair, required equipment and required skills, wherein the identification is done in real time.

11. A computer system comprising:
one or more processors; and
a memory coupled to the one or more processors, the memory for storing instructions which, when executed by the one or more processors, cause the one or more processors to perform a method for real time assignment of servicemen in an event of fault detection in a facility, the method comprising:
receiving, at a fault detection system, a first set of data from a facility management system, wherein the facility management system is associated with a plurality of sensors, wherein the plurality of sensors is installed at a plurality of equipment in the facility, wherein the first set of data is time series data, wherein the first set of data is received in real time;
fetching, at the fault detection system, a past experience data from one or more databases, wherein the past experience data is associated with past experiences of a plurality of servicemen, wherein the past experience data is fetched in real time;
analyzing, at the fault detection system, the first set of data and the past experience data, wherein the analysis is done using one or more machine learning algorithms, wherein the first set of data and the past experience data are analysed in real time;
detecting, at the fault detection system, one or more faults in the at least one equipment of the plurality of equipment installed in the facility based on the analysis of the first set of data, wherein the one or more faults is detected in real time;
generating, at a ticket generation system, one or more tickets in the event of detection of the one or more faults in the at least one equipment of the plurality of equipment installed in the facility, wherein the one or more tickets comprising a plurality of parameters associated with the one or more faults, wherein the one or more tickets are generated in real time;
assigning, at the ticket generation system, the plurality of servicemen for handling the one or more faults detected in the at least one equipment of the plurality of equipment installed in the facility, wherein the assignment of the plurality of servicemen is based on a plurality of factors, wherein the assignment of the plurality of servicemen is done in real time;
alerting, at the ticket generation system, the plurality of servicemen assigned for handling the one or more faults detected in the at least one equipment of the plurality of equipment installed in the facility, wherein the alert is sent to the plurality of servicemen in real time; and
sending, at the ticket generation system, a plurality of information about the one or more faults associated with the plurality of equipment installed in the facility to the plurality of servicemen assigned to handle the one or more faults.

12. The computer system as recited in claim 11, wherein the plurality of equipment comprising air handling unit, de-humidifiers, escalators, heating unit, ventilation unit, air conditioning unit, boiler unit, distribution board, transformer, electricity meter, air conditioning system, fire detection system, circuit breaker, elevator system, electricity meter, circuit disconnects, junction boxes, electric switchgears, lightening system, electronic lock system, and intercom system.

13. The computer system as recited in claim 11, wherein the first set of data comprising facility temperature, usage time of equipment, equipment behaviour, equipment temperature, equipment output, equipment efficiency and equipment fault history.

14. The computer system as recited in claim 11, wherein the past experience data comprising total experience, field of expertise, past handled faults, customer's review, mean time to repair, current location, and current availability.

15. The computer system as recited in claim 11, wherein the plurality of parameters comprising facility location, faulty equipment placement, type of fault, mean time to repair, required skills, and required equipment.

16. The computer system as recited in claim 11, wherein the one or more faults comprising short circuit fault, equipment failure, symmetrical fault, unsymmetrical fault, temperature fault, efficiency fault, equipment noise fault, circuit overload and lightening fault.

17. The computer system as recited in claim 11, wherein the plurality of sensors comprising dynamic pressure sensor, smoke sensor, infrared sensor, humidity sensor, temperature sensor, occupancy sensor, duct sensor, proximity sensor, light sensor, air quality sensor, touch sensor, biometric sensor, motion sensor heating ventilation and air conditioning sensor, vibration sensor and ultrasonic sensor.

18. A non-transitory computer-readable storage medium encoding computer executable instructions that, when executed by at least one processor, performs a method for real time assignment of servicemen in an event of fault detection in a facility, the method comprising:
receiving, at a computing device, a first set of data from a facility management system, wherein the facility management system is associated with a plurality of sensors, wherein the plurality of sensors is installed at a plurality of equipment in the facility, wherein the first set of data is time series data, wherein the first set of data is received in real time;
fetching, at the computing device, a past experience data from one or more databases, wherein the past experience data is associated with past experiences of a plurality of servicemen, wherein the past experience data is fetched in real time;
analyzing, at the computing device, the first set of data and the past experience data, wherein the analysis is done using one or more machine learning algorithms, wherein the first set of data and the past experience data are analysed in real time;
detecting, at the computing device, one or more faults in the at least one equipment of the plurality of equipment installed in the facility based on the analysis of the first set of data, wherein the one or more faults is detected in real time;
generating, at the computing device, one or more tickets in the event of detection of the one or more faults in the at least one equipment of the plurality of equipment installed in the facility, wherein the one or more tickets comprising a plurality of parameters associated with the one or more faults, wherein the one or more tickets are generated in real time;
assigning, at the computing device, the plurality of servicemen for handling the one or more faults detected in the at least one equipment of the plurality of equipment installed in the facility, wherein the assignment of the plurality of servicemen is based on a plurality of factors, wherein the assignment of the plurality of servicemen is done in real time;
alerting, at the computing device, the plurality of servicemen assigned for handling the one or more faults detected in the at least one equipment of the plurality of equipment installed in the facility, wherein alert is sent to the plurality of servicemen in real time; and
sending, at the computing device, a plurality of information about the one or more faults associated with the at least one equipment of the plurality of equipment installed in the facility to the plurality of servicemen assigned to handle the one or more faults.

19. The non-transitory computer-readable storage medium as recited in claim 18, wherein the plurality of equipment comprising air handling unit, de-humidifiers, escalators, heating unit, ventilation unit, air conditioning unit, boiler unit, distribution board, transformer, electricity meter, air conditioning system, fire detection system, circuit breaker, elevator system, electricity meter, circuit disconnects, junction boxes, electric switchgears, lightening system, electronic lock system, and intercom system.

20. The non-transitory computer-readable storage medium as recited in claim 18, wherein the first set of data comprising facility temperature, usage time of equipment, equipment behaviour, equipment temperature, equipment output, equipment efficiency and equipment fault history.
